(19) United States
(12) Patent Application Publication
(10) Pub. No.: US 2014/0125262 A1
(43) Pub. Date: May 8, 2014

(54) Circuit For Monitoring The Operation Of An Electric Motor

(71) Applicant: Control Techniques Limited, Newtown (GB)

(72) Inventors: Simon David Hart, Welshpool (GB); Antony John Webster, Montgomery (GB); Kondala Rao Gandu, Newtown (GB)

(73) Assignee: Control Techniques Limited, Newtown (GB)

(21) Appl. No.: 14/068,464

(22) Filed: Oct. 31, 2013

(30) Foreign Application Priority Data
Nov. 2, 2012 (GB) 1219739.8

(51) Int. Cl. H02P 6/00

(52) U.S. Cl. CPC H02P 6/001
USPC 318/400.04

(57) ABSTRACT

A circuit for monitoring the operation of an electric motor comprises means for deriving a motor signal indicative of a relatively low frequency characteristic of the motor commutation current (for example the back EMF ripple) by rejecting the high frequency components which are mainly the result of the commutation events. The circuit also includes means for producing a pulse from the low frequency characteristic which has a duration related to the motor speed.

### CROSS-REFERENCE TO RELATED APPLICATION

This application claims the benefit and priority of Great Britain Patent Application No. 1219739.8 filed Nov. 2, 2012. The entire disclosure of the above application is incorporated herein by reference.

### FIELD

This invention relates to a circuit for monitoring the operation of an electric motor, particularly a brushless DC (BLDC) motor driving a cooling fan.

### BACKGROUND

The class of electric motors known as brushless DC motors (BLDCs) are characterised by not having any electrical contact between the stator and the rotor. Commutation of the motor is controlled by switching the voltage across the stator windings according to the sensed position of the rotor. Within the commutation cycle in a waveform of the commutation current in the windings as commutation takes place there are high frequency components (spikes) associated with the commutation events, and low frequency components amongst which are the parts of the commutation waveform caused by the back EMF due to the inductance of the windings (ripple). As the speed of the motor changes, the frequency of cycle of events in the waveform increases as a rate of commutation of the windings increases.

In monitoring the rotation of a BLDC motor it is natural to assume that the high frequency spikes associated with the commutation events constitute the clearest point in the waveform to monitor for (e.g.) motor speed. To this end, it has been proposed in the past to focus on the spikes and to discard the rest of the waveform as not containing useful information. An example of such a system is disclosed in U.S. Pat. No. 6,054,823 which refers to the high frequency information as “desired” and the low frequency information as “unwanted”.

In practice, however, utilising the high frequency commutation spikes is not straightforward. Firstly, in practice the spikes are buried within the waveform and not easily isolated. Secondly, it is found that the shape and magnitude of the spike will vary between motors and types of motor. They are also temporally narrow. Thus, when designing a system for monitoring for failure of an electric motor, the use of the spikes is more difficult than first appears.

A typical use of a BLDC motor is in powering a fan in (e.g.) a computer cabinet for cooling the working parts. If the fan were to fail it would lead to damage of the computer due to overheating. Therefore, it is important in this and many other applications for the operation of the motor to be monitored to make sure that it is running effectively. In the event that the motor fails, or its effectiveness is otherwise compromised, an alert or other action would need to be signalled so that either the user or the application can take remedial action in relation to operation of the associated devices to avoid or mitigate any consequent damage due to motor failure. Hence, there is a need for a reliable and broadly applicable means of monitoring the motor operation that does not require direct access to the motor itself, nor any complicated setting up procedures given that it should be universally applicable in many diverse situations.

### SUMMARY

Disclosed embodiments herein provide an improved circuit for monitoring operation.

According to disclosed embodiments, there is provided a circuit for monitoring the operation of an electric motor comprising means for deriving a motor signal indicative of a relatively low frequency characteristic of the motor commutation current by rejecting a relatively high frequency component of the motor commutation current; and means for producing a pulse having a duration related to motor speed from the motor signal.

Preferably, the low frequency characteristic is based on the back EMF ripple in the motor commutation current. This is a characteristic of many kinds of motor and it has been found that it can be derived reliably by rejecting high frequency components as described herein.

Preferably, the means for producing a pulse comprise a threshold circuit providing an output pulse from a comparison of a signal indicative of the motor commutation current and an average of the motor commutation current. Preferably, the motor commutation current is low pass filtered with a time constant such as to produce a substantially constant average of the motor commutation current.

Preferably, the means for producing comprise an output operable to derive a signal having a magnitude indicative of the motor speed from the pulse. The output may, for example, comprise a capacitor which holds a charge in inverse relationship to the duration of the pulse such that the voltage across the capacitor is inversely related to the motor speed.

The output of the circuit can be applied either to a control function for carrying out action in the event of failure of the motor or to provide an output in the form of user interface alert to signify that the motor has failed or that its operation has been compromised. For example, in the case of fan motor for a computer, the output of the circuit could be returned to the controlling microprocessor in order for it to effect action to avoid the computer overheating.

### DRAWINGS

Embodiments will now be described with reference to the accompanying drawings, in which:

FIG. 1 is a circuit diagram of a circuit for monitoring the operation of an electric fan motor; and

FIG. 2 is a set of waveforms based on a commutation current for the motor depicted in FIG. 1.

### DETAILED DESCRIPTION

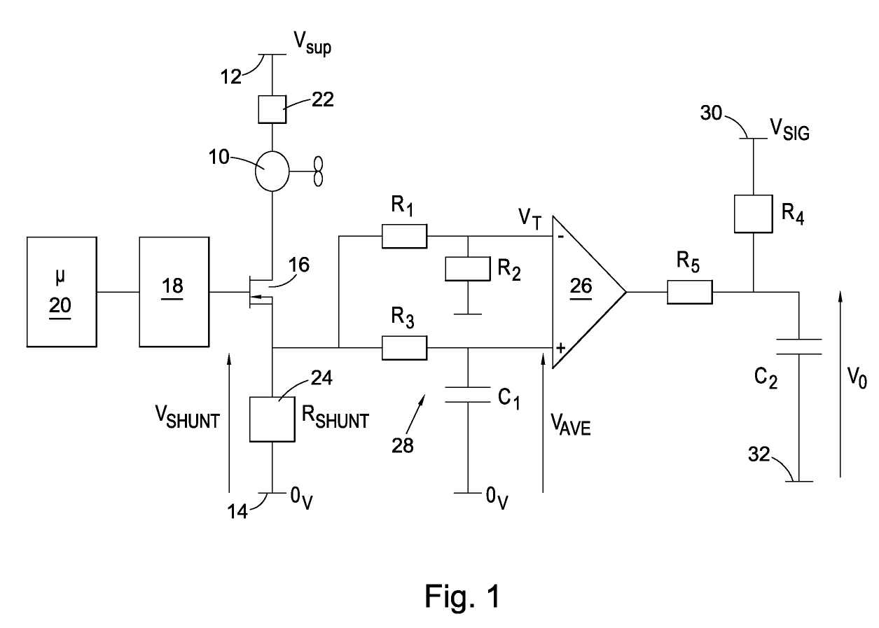

Referring to FIG. 1, a fan drive circuit for a computer comprises a BLDC fan motor 10 driving a fan and connected between electrical supply rails 12 and 14. The fan is arranged to blow cooling air through the cabinet of a controller based on a processor: a typical controller would be the drive for an electric motor. The voltage across the motor windings is controlled by a switch arrangement schematically shown as a single insulated gate bipolar transistor 16 (power transistor). Of course, the BLDC motor 10 may include many phases and the power switching arrangement for controlling the or each phase may comprise other power switching devices and arrangements thereof. The schematic representation of the motor and the switch arrangement is for illustrative purposes only. The power transistor 16 is controlled by a gate driver circuit 18 operated by a microprocessor 20. Shunt resistors 22 and 24 are arranged in series with the motor 10 and the power transistor 16 between the positive and ground potential supply rails 12 and 14. The shunt resistor 24 provides a voltage drop by which a signal indicative of the commutation current can be derived as Vshunt. An operational amplifier 26 acts as a comparator. The inverting input to the op amp 26 is fed with a threshold voltage VT set by resistors R1 and R2 from the voltage across the shunt resistor 24. The same signal provided from across the shunt resistor 24 is filtered using a long time constant low pass filter 28 based on R3 and Cl. The output of the filter 28 is an average of the shunt voltage and is essentially a substantially constant value which is connected to the non-inverting input of the op amp 26.

The output of the op amp 26 is connected in series with a resistor R5 and resistor/capacitor arrangement R4 and C2 across the resistor R5 and between the signal voltage rails 30 and 32. The signal voltage V_{SIG} referred to herein is conveniently taken from the supply voltage for the microprocessor 20.

In the circuit the threshold voltage VT at the inverting input to the op amp 26 is derived by the ratio of resistors R1 and R2 and the ratio of the threshold voltage to the average voltage is:

$$\frac{R 1 + R 2}{R 2}$$

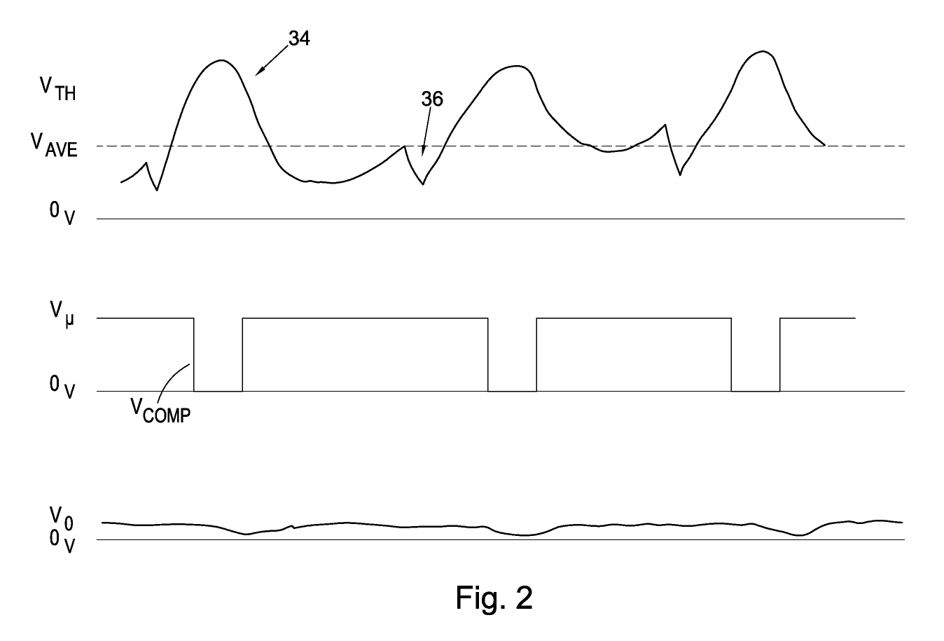

The circuit relies on a determination of the low frequency event 34 of the back EMF ripple in the motor as shown in FIG. 2 in which the high frequency commutation spikes 36 can also be identified. To isolate the low frequency back EMF part of the waveform, the high frequency components of the commutation current must be rejected in the signal derived from it.

In the circuit the time constant of R5 and C2 is arranged to be significantly less than the time constant of R4 and C2 in the output of the op amp 26. This means that the capacitor C2 is rapidly discharged. At the operating speed of the fan the output of the comparator op amp 26 is a sequence of relatively narrow pulses Vcomp based on the back EMF ripple, resulting in the near-zero voltage output across the capacitor C2 Vo. As the speed of the fan decreases due, for example, to a fault in the motor, the duration of the pulses increases, causing the voltage Vo across the capacitor to rise as its charge is maintained due to the voltage sustained across it by the longer duration pulses.

If the fan stops the voltage Vo across the capacitor C2 rises to the signal supply voltage at 30 V_{SIG}. Between full fan operating speed and standstill the voltage is between full signal voltage and substantially zero. It can be seen that intermediate speeds of the fan can be equated to voltages intermediate V_{SIG} and ground. Thus, it can be chosen that a voltage of Vo (e.g.) O.5V_{SIG} and zero means the fan is working properly or sufficiently well for it to provide adequate cooling. Between V_{SIG} and 0.5 V_{SIG} means that the fan is not operating sufficiently well to cool the equipment. These are examples of decisions that can be taken either for the system to take action or for an alarm to be initiated. Other proportions between supply volts V_{SIG} and ground can be used according to applications.

Depending on the application to which the circuit is put, the output Vo can be connected to an analogue-to-digital convertor for signal processing or can be otherwise conditioned for use in another circuit to provide an input to trigger remedial action aimed at avoiding of mitigating component damage, or to provide a user alarm for action to be taken.

1. A circuit for monitoring the operation of an electric motor comprising means for deriving a motor signal indicative of a relatively low frequency characteristic of the motor commutation current by rejecting a relatively high frequency component of the motor commutation current; and means for producing a pulse having a duration related to motor speed from the motor signal comprising a threshold circuit providing an output of a comparison of a signal indicative of the motor commutation current and an average of the motor commutation current.

2. A circuit as claimed in claim 1 in which the threshold circuit comprises a low pass filter producing the average signal which is substantially constant.

3. A circuit as claimed in claim 1 in which the means for producing comprise an output operable to derive a signal having a magnitude indicative of the motor speed from the pulse.

4. A circuit as claimed in claim 3 in which the output comprises a capacitor which discharges in inverse relationship to the duration of the pulse applied such that the voltage across the capacitor is related to the motor speed.

5. An electric motor drive comprising an electric motor controlled by a switch arrangement and a circuit as claimed in claim 1 in which the means for deriving are connected to receiving a signal indicative of the current through the switch arrangement.

6. A drive as claimed in claim 5 in which the electric motor is a brushless DC motor.

7. A drive as claimed in claim 5 in which the relatively low frequency characteristic of the motor commutation current is back EMF ripple.

8. A drive as claimed in claim 5 in which the drive is operably connected to run a cooling fan.
